(19) United States
(12) Patent Application Publication
(10) Pub. No.: US 2025/0178357 A1
(43) Pub. Date: Jun. 5, 2025

(54) LIQUID DISCHARGE APPARATUS

(71) Applicant: Hiroyoshi MATSUMOTO, KANAGAWA (JP)

(72) Inventor: Hiroyoshi MATSUMOTO, KANAGAWA (JP)

(21) Appl. No.: 18/938,297

(22) Filed: Nov. 6, 2024

(30) Foreign Application Priority Data
Nov. 30, 2023 (JP) 2023-202820

(51) Int. Cl. B41J 2/21; B41F 16/02; B41J 2/165; B41M 5/00; B41M 7/00

(52) U.S. Cl. CPC B41J 2/2114; B41F 16/02; B41J 2/16505; B41J 2/16552; B41M 5/0047; B41M 7/0081; B41J 2002/16558

(57) ABSTRACT

A liquid discharge apparatus includes a first discharge unit, a second discharge unit, and a third discharge unit. The first discharge unit has a first nozzle face having a first nozzle to discharge ink from the first nozzle onto an area of a recording medium to form an image on the recording medium. The second discharge unit has a second nozzle face having a second nozzle to discharge a pretreatment liquid from the second nozzle to the area of the recording medium. The third discharge unit has a third nozzle face having a third nozzle to discharge a diluent from the third nozzle.

### CROSS-REFERENCE TO RELATED APPLICATION

This patent application is based on and claims priority pursuant to 35 U.S.C. § 119(a) to Japanese Patent Application No. 2023-202820, filed on Nov. 30, 2023, in the Japan Patent Office, the entire disclosure of which is hereby incorporated by reference herein.

### BACKGROUND

### Technical Field

Embodiments of the present disclosure relate to a liquid discharge apparatus.

### Related Art

In the related art, an inkjet printer that directly prints images or letters on a T-shirt, a tote bag, a hat, and other garments is known as a garment printer.

### SUMMARY

Embodiments of the present disclosure describe an improved liquid discharge apparatus that includes a first discharge unit, a second discharge unit, and a third discharge unit. The first discharge unit has a first nozzle face having a first nozzle to discharge ink from the first nozzle onto an area of a recording medium to form an image on the recording medium. The second discharge unit has a second nozzle face having a second nozzle to discharge a pretreatment liquid from the second nozzle to the area of the recording medium. The third discharge unit has a third nozzle face having a third nozzle to discharge a diluent from the third nozzle.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a liquid discharge apparatus according to an embodiment of the present disclosure, with covers closed;

FIG. 2 is a plan view of the liquid discharge apparatus of FIG. 1;

FIG. 3 is a perspective view of the liquid discharge apparatus of FIG. 1 with the covers open;

FIG. 4 is a plan view of the liquid discharge apparatus of FIG. 3;

FIG. 5A is a schematic plan view of heads according to the present embodiment;

FIG. 5B is a schematic plan view of nozzles arranged in the heads of FIG. 5A;

FIG. 6 is a schematic cross-sectional view of a wiping member of the liquid discharge apparatus to which a diluent is applied, according to the present embodiment; and

FIG. 7 is a schematic cross-sectional view of a cap of the liquid discharge apparatus according to the present embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid discharge apparatus according to embodiments of the present disclosure is described below with reference to the drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure.

A liquid discharge apparatus according to an embodiment of the present disclosure includes a first discharge unit that discharges ink onto a recording medium, a second discharge unit that discharges a pretreatment liquid to an area to which the ink is to be discharged, and a third discharge unit that discharges a diluent.

A typical garment printer can print white images or letters as well as black, yellow, cyan, and magenta images or letters. For example, when printing an image on a color cloth (recording medium) other than a white cloth, the garment printer discharges white ink and then discharges color ink thereon to form a desired image. In this case, the white ink is kept on the surface of the recording medium. When the garment printer discharges ink onto cloth to form an image thereon, the ink may permeate into the texture of the cloth. Accordingly, the garment printer may fail to form a desired image. For this reason, in a comparative example, a coater, a spray device, or another device, which is independent of the liquid discharge apparatus, is used to apply a pretreatment liquid to the recording medium in advance. However, it may take a lot of time and effort to use the independent device to apply the pretreatment liquid, and thus the productivity of images is not enhanced.

To solve the above situation, a liquid discharge apparatus according to the present embodiment includes a first discharge unit that discharges ink onto a recording medium and a second discharge unit that discharges a pretreatment liquid to an area to which the ink is to be discharged. Such a configuration can enhance the productivity. One example of each discharge unit is a liquid discharge head. The liquid discharge head may be referred to simply as the head.

In the above configuration, a mist of pretreatment liquid may adhere to the head, the surroundings of the head, and the interior of the system. Then, when ink is discharged, a mist of ink may bind to the adhered pretreatment liquid, causing an ink stain mixed with the pretreatment liquid. To prevent the ink stain, for example, areas around nozzles of the head and the interior of the system may be cleaned with a cleaning liquid to maintain the head. In this case, some process units, for example, a unit that stores the cleaning liquid and some other liquids and another unit that supplies the cleaning liquid may be added to the liquid discharge apparatus. As a result, manufacturing costs of the liquid discharge apparatus may increase.

For this reason, the liquid discharge apparatus according to the present embodiment further includes a third discharge unit having the same configuration as the first discharge unit and the second discharge unit. The third discharge unit uses a diluent. The diluent dilutes at least one of the pretreatment liquid or the ink. Usage of the diluent does not require the additional units and can prevent an increase in manufacturing costs of the liquid discharge apparatus. The diluent is used to clean the areas around the nozzles and some other areas and to perform a maintenance operation of the head. Such an operation can keep the areas around the nozzles clean. The third discharge unit may discharge the diluent onto formed images.

The areas around the nozzles may correspond to the areas around the nozzles through which the pretreatment liquid is discharged or the areas around the nozzles through which the ink is discharged. The areas around the nozzles may correspond to a portion of a nozzle face of the head or the entire area of the nozzle face.

The recording medium may be referred to as, for example, the print medium or the medium. The recording medium can be selected as appropriate. Examples of the recording medium include plain paper, glossy paper, special paper, cloth (also referred to as fabric), a film, an overhead projector (OHP) transparency, and general-purpose print paper.

The pretreatment liquid includes an ingredient that fixes ink quickly. The pretreatment liquid may include, for example, a coagulant, an organic solvent, and water and may further include a surfactant, a defoamer, a pH adjuster, a preservative, a fungicide, and a corrosion inhibitor.

The organic solvent, the surfactant, the defoamer, the pH adjuster, the preservative, the fungicide, and the corrosion inhibitor may be made of the same materials as used for the ink or may be made of materials used for known treatment liquids.

The type of the coagulant is not limited to any particular type, and examples thereof include water-soluble cationic polymers, acids, and polyvalent metal salts.

The pretreatment liquid used in the present embodiment can be prescribed, for example, as in Table 1 below. This prescription allows the ink to be discharged over the pretreatment liquid which has not been dried and is still wet, and thus the productivity can be enhanced.

TABLE 1
Composition Example of Pretreatment Liquid

| substance name | content (%) |
|---|---|
| calcium nitrate tetrahydrate | 30 to 50 |
| glycol | 10 to 20 |
| glycerin | 0 to 10 |
| water | 25 to 35 |

In Table 1, the glycol is not particularly limited and can be selected as appropriate. Calcium nitrate tetrahydrate is an example of the coagulant. The numerical range of the content (%) in Table 1 indicates “equal to or more than” to “equal to or less than.”

The ink can be selected as appropriate. One or more types of ink may be used. When multiple types of ink are used, for example, black ink, cyan ink, magenta ink, and yellow ink can be used. In addition, white ink, clear ink, and other types of ink can be used.

The ink may be ink containing water as a main ingredient or ink containing an organic solvent as a main ingredient. As the main ingredient, the content of water or organic solvent in the ink is preferably 90% or more by mass or more preferably 95% or more by mass.

When ink containing an organic solvent as a main ingredient is used, an apparatus having a configuration that uses a diluent is further effective in keeping the areas around the nozzles clean. Ink containing an organic solvent as a main ingredient is more likely to stain, for example, the areas around the nozzles than ink containing water as a main ingredient. The diluent can dilute ink and facilitate the removal of the ink adhering to the areas around the nozzles.

Examples of the organic solvent include, but are not limited to, polyhydric alcohols, ethers such as polyhydric alcohol alkyl ethers and polyhydric alcohol aryl ethers, nitrogen-containing heterocyclic compounds, amides, amines, and sulfur-containing compounds.

The prescription example of the black ink is listed in Table 2 below. In Table 2, the glycol is not particularly limited and can be selected as appropriate.

TABLE 2
Composition Example of Black Ink

| substance name | content (%) |
|---|---|
| carbon black | 0 to 10 |
| glycol | 15 to 25 |
| glycerin | 5 to 15 |
| diethylene glycol monobutyl ether | 0 to 3 |
| acetone | <1 |
| 2-dimethylaminoethanol | <1 |
| water | 40 to 60 |

Table 2 illustrates the prescription example of the black ink, but such a prescription can also be applied to another ink. In the case of another ink, carbon black marked with the asterisk “*” in Table 2 may be replaced with another colorant. One example of the colorant is a pigment.

The ink may be ultraviolet-curable ink. In this case, the liquid discharge apparatus preferably includes an irradiation unit that emits ultraviolet light. With the liquid discharge apparatus including the irradiation unit, another device is unnecessary to emit the ultraviolet light. As a result, the productivity can be enhanced. The ultraviolet-curable ink adhering to the head or the surroundings of the head may be difficult to remove. Even in this case, the diluent can dilute the ink and facilitate the removal of the adhered ink. It would be better if the ultraviolet-curable ink could be washed off with the diluent before the ink is firmly adhered (fixed) to the head or the surroundings of the head.

The ultraviolet-curable ink contains, for example, a polymerizable compound (monomer, oligomer, etc.), a polymerization initiator, a colorant, and an organic solvent.

The diluent may be any liquid that can dilute the pretreatment liquid and may be selected appropriately. A liquid including an ingredient used as a solvent of the pretreatment liquid is used as the diluent in the present embodiment.

The diluent can be selected as appropriate, and the diluent is preferably water. When the diluent is water, the water can be easily prepared, and the configuration of the apparatus can be simplified. The water is not particularly limited and may be pure water. The phrase “the diluent is water” includes the diluent containing the water as a main ingredient. The content of water as a main ingredient in the diluent is, for example, preferably 90% or more by mass or more preferably 95% or more by mass.

When water is used as the diluent in the present embodiment, for example, the diluent can be prescribed as in Table 3 below. In Table 3, the preservative is not particularly limited and can be selected as appropriate. In the prescription listed in Table 3, the diluent contains 95% of water by mass, which means that water is the main ingredient.

TABLE 3
Composition Example of Diluent

| substance name | content (%) |
|---|---|
| preservative | ≤5 |
| water | ≥95 |

The diluent is preferably a cleaning liquid instead of water. The cleaning liquid in the present embodiment contains an organic solvent, a surfactant, and water. When the diluent is the cleaning liquid, the diluent can easily remove stain (e.g., the ink stain). For example, a cleaning liquid for cleaning the interior of an ink supply path is effective as the cleaning liquid used in the present embodiment.

The cleaning liquid used in the present embodiment can be, for example, prescribed as in Table 4 below. In Table 4, the glycol is not particularly limited and can be selected as appropriate. The surfactant is not particularly limited and can be selected as appropriate.

TABLE 4
Composition Example of Cleaning Liquid

| substance name | content (%) |
|---|---|
| glycol | 20 to 30 |
| glycerin | <10 |
| surfactant | <3 |
| water | 55 to 75 |

Both the pretreatment liquid and the diluent are preferably transparent. The transparent pretreatment liquid and diluent discharged onto the recording medium are inconspicuous on the recording medium.

In the present embodiment, the diluent dilutes at least one of the pretreatment liquid or the ink. In this case, the nozzle faces of the first discharge unit and the second discharge unit can be easily kept clean. When the diluent dilutes both the pretreatment liquid and the ink, the diluent can be shared to dilute the ink and to dilute the pretreatment liquid. As a result, the number of types of diluent is not required to be increased. Since an additional third discharge unit is unnecessary, an increase in manufacturing costs of the liquid discharge apparatus can be prevented.

To dilute the pretreatment liquid or the ink with the diluent, for example, the diluent includes at least one of the solvents contained in the pretreatment liquid or the ink. For example, the diluent including at least one of the solvents contained in the pretreatment liquid or the ink can dilute at least one of the pretreatment liquid or the ink. To dilute both the pretreatment liquid and the ink with the diluent, for example, the diluent includes the solvent contained in the pretreatment liquid and the ink.

In the examples in Tables 1 to 3 above, each of the pretreatment liquid, the ink, and the diluent includes water. In the examples in Tables 1, 2, and 4, each of the pretreatment liquid, the ink, and the diluent (cleaning liquid) preferably includes water and glycerin. In this case, the nozzle faces of the first discharge unit and the second discharge unit can be easily cleaned and kept clean.

The diluent that dilutes the ink has the following effects in addition to the above. For example, pigment ingredients such as titanium dioxide in white ink are likely to sediment and remain in the nozzles, which may cause a discharge failure. In the present embodiment, the diluent can dilute the ink. Accordingly, for example, a wiping member (i.e., a wiper) holding the diluent wipes the nozzles (nozzle face) to prevent the discharge failure.

The application of the diluent can be selected as appropriate. The diluent may be brought into direct contact with the pretreatment liquid or the ink, or may be used by a method other than the direct contact. For example, the diluent is applied to a component such as the wiping member and used to clean the areas around the nozzles to which the pretreatment liquid or the ink adheres. In this case, the diluent may be applied to a component other than the wiping member. When the diluent is used to wash out the pretreatment liquid or the ink, the diluent can dilute or soften the pretreatment liquid or the ink from which moisture has evaporated, the viscosity of which has increased, and which is about to be solidified. In this way, the diluent can appropriately clean, for example, the nozzle face of the head.

Examples of the area to be cleaned by the wiping member include the areas around the nozzles through which the pretreatment liquid is to be discharged and the areas around the nozzles through which the ink is to be discharged. In addition to these areas, for example, the nozzle face such as the surroundings of the nozzles and a portion of the head other than the nozzle face may be cleaned. Moreover, a component other than the head may be cleaned. The diluent may be brought into direct contact with the pretreatment liquid or the ink that has been discharged.

As the application of the diluent, in addition to the above, the diluent may be used for a cap that covers the nozzles. The cap holding the diluent covers the nozzles to prevent the pretreatment liquid or the ink from being dried. For example, even when a printing operation is not performed for a long time, the nozzles are not clogged with the pretreatment liquid or the ink, and thus the discharge failure can be prevented.

The timing of using the diluent can be selected as appropriate. As an example, after wiping by the wiping member, the diluent may be discharged at the timing when a user requests a refreshing operation. As another example, the diluent may be discharged at the timing when the printing operation is restarted after the printing operation is not performed for a long time. In the print pattern to be printed at the time of nozzle check, the diluent is not necessarily discharged.

As described above, the liquid discharge apparatus according to the present embodiment includes the third discharge unit that discharges the diluent. A liquid discharge head can be used as the third discharge unit. A liquid discharge apparatus having a configuration in which the diluent is discharged onto the liquid discharge head can reduce the manufacturing costs of the apparatus. The liquid discharge apparatus according to the present embodiment does not require a dedicated device that supplies the diluent. In addition, the third discharge unit can have the same configuration as the first discharge unit and the second discharge unit. Consequently, additional costs can be reduced.

In the liquid discharge apparatus including the third discharge unit that discharges the diluent, for example, the diluent can be discharged to the cap. In addition, the diluent is slightly discharged but not completely discharged as a droplet, and a discharged diluent can be kept in the areas around the nozzles. For example, the third discharge unit includes a driver to drive the third discharge unit with a low drive frequency to keep the diluent in the areas around the nozzles, which is not discharged as a droplet. The operation of keeping the diluent in the areas around the nozzles without discharging the diluent as a droplet may be referred to as, for example, the operation of causing the diluent to ooze out.

In a liquid discharge apparatus using the diluent, an additional unit may be provided for a supply path of the liquid discharge head to supply the diluent to the nozzles through which the pretreatment liquid or the ink is to be discharged for direct maintenance. In this case, however, the modification of the liquid discharge apparatus may incur increased manufacturing costs.

The liquid discharge apparatus according to the present embodiment includes the first discharge unit and the second discharge unit, which can discharge, respectively, the pretreatment liquid and the ink. Accordingly, another apparatus is unnecessary to perform a pretreatment on the recording medium, and thus the productivity can be enhanced. The liquid discharge apparatus according to the present embodiment can discharge both the pretreatment liquid and the ink and further include the third discharge unit that discharges the diluent. Accordingly, the diluent can be used without an increase in manufacturing costs. The liquid discharge apparatus according to the present embodiment can perform processes ranging from the pretreatment to printing by itself and can be appropriately maintained without an increase in manufacturing costs.

A liquid discharge apparatus according to the present embodiment is described below. An example of a digital to garment or direct to garment (DTG) system will be described below, but the liquid discharge apparatus of the present embodiment is also applicable to a digital to film or direct to film (DTF) system.

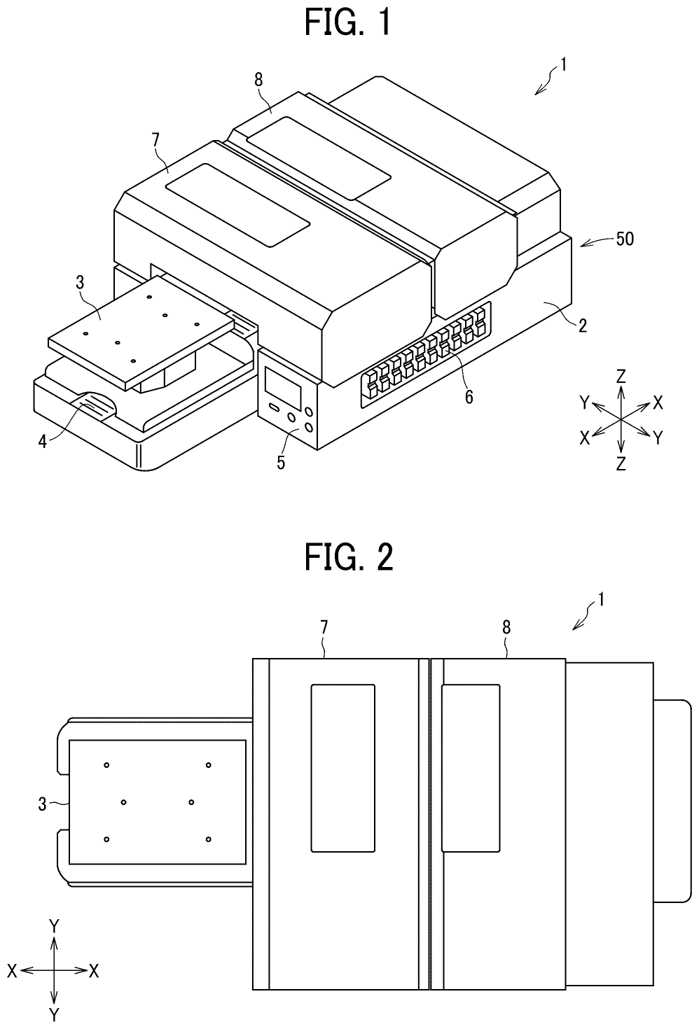

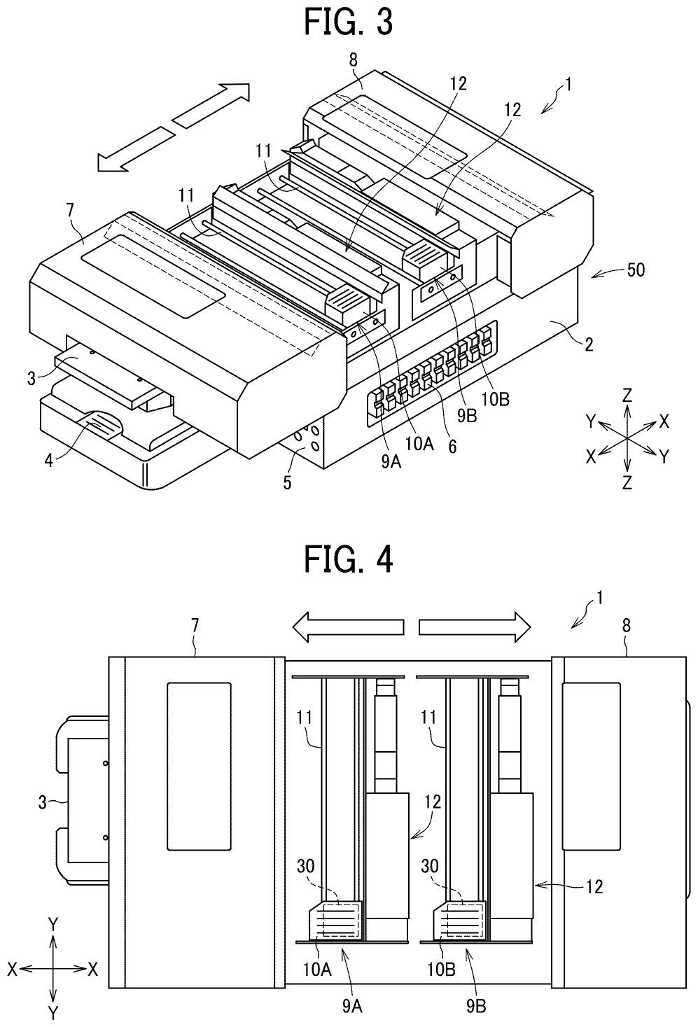

FIG. 1 is a perspective view of a liquid discharge apparatus 1 according to an embodiment of the present disclosure, with covers closed, and FIG. 2 is a plan view thereof. FIG. 3 is a perspective view of the liquid discharge apparatus 1 of FIG. 1, according to the present embodiment, with the covers open, and FIG. 4 is a plan view thereof. Directions X in FIG. 1 are the front-rear direction, sub-scanning direction, and recording-medium conveyance direction of the liquid discharge apparatus 1. Directions Y in FIG. 1 are the transverse direction and main scanning direction of the liquid discharge apparatus 1. Directions Z in FIG. 1 are the vertical directions of the liquid discharge apparatus 1. The X directions and the Y directions are parallel to a surface, onto which a liquid is discharged, of a recording medium on a stage 3, but may have some error. The X, Y, and Z directions are orthogonal to each other.

As illustrated in FIGS. 1 and 2, the liquid discharge apparatus 1 includes the stage 3 in front of a housing 2. The stage 3 is mounted on a guide rail 4. The guide rail 4 extends in the X directions. A control panel 5 is disposed on the front face of the housing 2. Ink cartridges 6 are detachably attached to a side face of the housing 2. A front cover 7 and a rear cover 8 as covers are disposed over the housing 2.

The stage 3 has a flat upper face on which the recording medium is placed. The upper face of the stage 3 is parallel to the directions X and the directions Y. The stage 3 moves on the guide rail 4 to reciprocate in both the directions X. The stage 3 is movable up and down in the directions Z. Thus, the height of the recording medium placed on the stage 3 is adjustable.

In FIG. 1, the front cover 7 has been moved backward and the rear cover 8 has been moved forward to close the front cover 7 and the rear cover 8 (i.e., a closed position). On the other hand, in FIG. 3, the front cover 7 is moved forward and the rear cover 8 is moved backward to open the front cover 7 and the rear cover 8 (i.e., an open position).

As described above, the front cover 7 and the rear cover 8 are slidably opened and closed. As a result, an occupied space of the liquid discharge apparatus 1 including an opening and closing space of each of the front cover 7 and the rear cover 8 can be reduced as compared with a configuration in which a front cover and a rear cover are opened and closed in the vertical directions. The front cover 7 and the rear cover 8 have openings at both ends in the front-rear direction. When the front cover 7 and the rear cover 8 are closed, the front cover 7 and the rear cover 8 are continuously arranged in the front-rear direction.

As illustrated in FIGS. 3 and 4, an apparatus body 50 of the liquid discharge apparatus 1 includes, for example, the housing 2 and liquid discharge units 9A and 9B mounted on the housing 2. In the present embodiment, specifically, the apparatus body 50 is a portion of the liquid discharge apparatus 1 other than the front cover 7 and the rear cover 8. The front cover 7 and the rear cover 8 are slidable in the directions X relative to the apparatus body 50.

The front cover 7 and the rear cover 8 are opened to expose the liquid discharge units 9A and 9B to the outside of the liquid discharge apparatus 1. When the liquid discharge units 9A and 9B are exposed to the outside, an operator can clean a maintenance unit 30, the liquid discharge head, and the surroundings thereof, or can replace carriages. The front cover 7 and the rear cover 8 are closed during image formation. As a result, the liquid discharge units 9A and 9B are covered by the front cover 7 and the rear cover 8 to block access to operation units such as the carriages of the liquid discharge units 9A and 9B from the outside.

The liquid discharge units 9A and 9B are disposed in the closed space in the front cover 7 or the rear cover 8. Accordingly, a mist of ink (liquid) is prevented from scattering to environs outside the liquid discharge apparatus 1 while the liquid discharge head discharges the ink to the recording medium (i.e., during liquid discharge operation). Further, the liquid discharge units 9A and 9B may include a fan to circulate airflow in the front cover 7 or the rear cover 8 to collect the generated mist of the ink (i.e., ink mist) in the front cover 7 or the rear cover 8.

The liquid discharge apparatus 1 according to the present embodiment includes the two liquid discharge units 9A and 9B arranged side by side in the directions X. The liquid discharge unit 9A discharges color ink and white ink. The liquid discharge unit 9B discharges a pretreatment liquid.

The liquid discharged by each of the liquid discharge units 9A and 9B is not limited to the above example, and any liquid of the color ink, the white ink, and the pretreatment liquid may be discharged by each of the liquid discharge units 9A and 9B. In particular, when the recording medium is cloth (fabric), the pretreatment liquid is preferably applied to the recording medium before the image formation using the ink. In other words, one of the liquid discharge units 9A and 9B preferably discharges the pretreatment liquid. The pretreatment liquid is preferably discharged from the liquid discharge unit 9B upstream from the liquid discharge unit 9A in the conveyance direction of the recording medium from the rear side to the front side of the liquid discharge apparatus 1.

Since the liquid discharge units 9A and 9B have similar configurations, the liquid discharge unit 9A is described below. The liquid discharge unit 9A includes a carriage 10A, a guide rod 11, an electrical component unit 12 including, for example, a board and an electrical component cover, and the maintenance unit 30. The liquid discharge units 9A and 9B and the carriages 10A and 10B may be referred to simply as a liquid discharge unit 9 and a carriage 10, respectively, unless distinguished.

The guide rod 11 extends in the main scanning direction. The carriage 10 is movable in the main scanning direction along the guide rod 11. The carriage 10 includes multiple liquid discharge heads. The maintenance unit 30 is disposed at a position facing the guide rod 11 outside a liquid discharge region on one side in the transverse direction (directions Y).

The maintenance unit 30 includes, for example, a wiping member that cleans a nozzle face of the liquid discharge head and a suction mechanism that sucks the nozzle face. The wiping member may be a wiper made of, for example, rubber, or a web made of, for example, nonwoven fabric.

The process of forming an image on the recording medium is described below.

The recording medium is placed on the stage 3 and conveyed along the guide rail 4. The recording medium is conveyed to the rear side of the liquid discharge apparatus 1, and the pretreatment liquid is applied to the recording medium by the liquid discharge unit 9B. Specifically, while the carriage 10B moves in the main scanning direction along the guide rod 11, the liquid discharge unit 9B discharges the pretreatment liquid from the nozzles of the liquid discharge head to apply the pretreatment liquid to the entire width of the recording medium in the main scanning direction. The application of the pretreatment liquid is repeated at multiple positions in the sub-scanning direction. As a result, the pretreatment liquid is applied to the entire recording medium.

After that, the stage 3 moves forward, and the liquid discharge unit 9A discharges the color ink of multiple colors onto the recording medium using a method similar to that of the liquid discharge unit 9B. When white color is printed on the recording medium, for example, the liquid discharge unit 9A discharges the white ink onto the recording medium, the stage 3 moves to the rear side of the liquid discharge unit 9A again, and the liquid discharge unit 9A discharges the color ink onto the recording medium. Thus, an image is formed on the recording medium.

A configuration example of supply units is described below. In FIGS. 1 and 3, the ink cartridges 6 are detachably attached, as the supply units, to the side face of the housing 2. The ten ink cartridges 6 are provided as illustrated in FIGS. 1 and 3. Although not limited to any particular arrangement, for example, the ink cartridges 6 respectively containing yellow ink, magenta ink, white ink, cyan ink, and black ink are disposed on the front side of the liquid discharge apparatus 1. Ink cartridges 6 respectively containing the pretreatment liquid and the diluent are disposed on the back side of the liquid discharge apparatus 1. In the present embodiment, as described above, the pretreatment liquid, the ink, and the diluent can be contained in the supply units having the same configuration.

The liquid discharge apparatus 1 is supplementally described below.

When cloth (fabric) is used as the recording medium, fluffing and wrinkles on the print face of the recording medium may be eliminated. Examples of the method of eliminating fluffing and wrinkles include a method of pressing the cloth with a heating surface of an iron or a heat presser. As described above, the recording medium used in the present embodiment may be processed before being placed in the liquid discharge apparatus 1 of the present embodiment.

When cloth is used as the recording medium, a platen may be used. The recording medium is attached to the platen so that no wrinkles (irregularities) are formed thereon. The platen holding the recording medium is attached to the stage 3 of the liquid discharge apparatus 1. The platen may be referred to as, for example, a holder. The liquid discharge apparatus 1 may perform an operation check after receiving a print command from a device, such as a personal computer (PC) or a smartphone.

The platen holding the recording medium is moved to a print start position on the back side of the liquid discharge apparatus 1. At this time, the height of the recording medium is detected by a built-in position sensor so that the upper portion of the recording medium does not come into contact with the nozzle face of the head. The distance between the surface of the recording medium and the nozzle face (may be referred to as a gap) is preferably as narrow as possible. The distance is set so that the surface of the recording medium and the nozzle face do not come into contact with each other. The gap is preferably, for example, 0.5 to 7 mm.

The position sensor detects, for example, whether the recording medium or the platen blocks a laser beam. When the laser beam is blocked, the liquid discharge apparatus 1 determines that an error has occurred. Then, the liquid discharge apparatus 1 stops the platen and returns the platen to the initial position on the front side of the liquid discharge apparatus 1. Preferably, the liquid discharge apparatus 1 automatically determines and adjusts the distance between the surface of the recording medium and the nozzle face.

After the platen has passed by the position sensor without an error, the liquid discharge apparatus 1 moves the platen to the print start position. The liquid discharge apparatus 1 receives a print start signal and then moves the platen to a leading write position.

Each of the carriages 10A and 10B moves along the guide rod 11, which extends in the main scanning direction, while reading an encoder disposed parallel to the guide rod 11 to discharge the liquid onto the recording medium attached to the platen. The moving direction of the carriages 10A and 10B is also referred to as the main scanning direction. The platen is moved along the guide rail 4 in the sub-scanning direction, in accordance with the movement of the carriages 10A and 10B. The printing operation is performed while the platen moves from the back side to the front side.

The liquid discharge apparatus 1 according to the present embodiment includes the two carriages (e.g., the carriage 10A on the front side and the carriage 10B on the back side). For example, the carriage on the back side includes heads that discharge the pretreatment liquid and heads that discharge the diluent, which are arranged side by side. The carriage on the front side includes heads that discharge color inks (e.g., yellow ink, magenta ink, cyan ink, and black ink) and heads that discharge white ink, which are arranged side by side.

The white ink and the color ink are printed on cloth by different methods. When printed on a white cloth, only the color ink may be discharged. When printed on a color cloth (e.g., a black cloth) other than a white cloth, if only the color ink is discharged, the color tone of the color ink may be changed due to the influence of the base color of the black cloth. To prevent this change of the color tone, when the printing operation is performed on a color cloth other than a white cloth, a white solid image is formed in the entire printing area on the color cloth with white ink. Then, the color cloth as a recording medium is moved to the print start position, and the color ink is discharged on the white solid image. In other words, an image formed of white ink and an image formed of color ink are superimposed one on another in the printing operation.

The above example is described below again. The ink includes color ink and white ink. The recording medium is cloth. When the color of the recording medium is not white, the first discharge unit discharges the white ink onto the recording medium and then discharges the color ink to an area of the recording medium to which the white ink has been discharged. Thus, the liquid discharge apparatus 1 can appropriately form a desired image even on a color cloth other than a white cloth.

After the ink has been discharged onto the recording medium, the recording medium is detached from the platen. Post-processing (e.g., heating and fixing) is performed by, for example, a heat presser as desired.

The liquid discharge apparatus 1 according to the present embodiment includes one head for each of white ink, cyan ink, magenta ink, yellow ink, and black ink. Although not particularly limited, the heads for the respective colors each have about 200 nozzles and are arranged parallel to one another. However, an embodiment of the present disclosure is not limited to such a configuration, and a plurality of heads may discharge one color ink. Similarly, a plurality of heads may be mounted for each of the pretreatment liquid and the diluent.

As described above, the recording medium can be selected as appropriate. For example, a cotton fabric or a synthetic fabric may be used as cloth. The cotton fabric may be thin or a canvas. The cloth can be selected as appropriate.

For example, when a thin polyester fabric is used as the recording medium, the pretreatment liquid is used.

The pretreatment liquid is discharged in advance and applied to an area to which the ink is to be discharged to form a desired image. When the liquid discharge apparatus 1 discharges the ink without discharging the pretreatment liquid, the ink may permeate deeply into the texture of cloth, so that a desired image may not be formed.

The arrangement of the first discharge unit, the second discharge unit, and the third discharge unit is not particularly limited and can be selected as appropriate. In the liquid discharge apparatus 1 according to the present embodiment, for example, the second discharge unit that discharges the pretreatment liquid is preferably disposed in the carriage on the back side because the print start position is positioned on the back side of the apparatus. This arrangement can enhance efficiency.

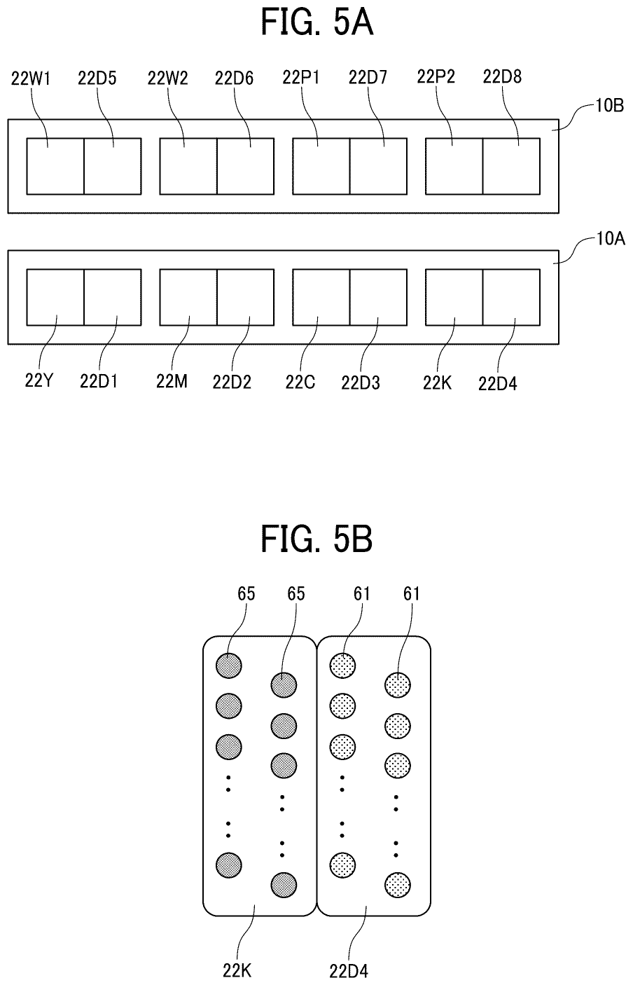

FIGS. 5A and 5B are schematic plan views of the heads arranged in the carriages 10A and 10B of the liquid discharge apparatus 1 of FIGS. 3 and 4. In FIGS. 5A and 5B, the heads are viewed in the direction from the recording medium toward the nozzle face. In the liquid discharge apparatus 1 according to an embodiment of the present disclosure, the number of carriages is not limited to two and can be changed as appropriate. The arrangement and number of heads are not limited to the example illustrated in FIGS. 5A and 5B and can be changed as appropriate.

In the example illustrated in FIG. 5A, the carriage 10A is provided with eight heads: heads 22Y, 22M, 22C, 22K, and 22D1 to 22D4, whereas the carriage 10B is provided with eight heads: heads 22W1, 22W2, 22P1, 22P2, and 22D5 to 22D8. These heads may be collectively referred to as, for example, heads 22, each of which may be referred to as a head 22 unless distinguished.

In the example illustrated in FIG. 5A, a garment printer Ri2000, which is manufactured by Ricoh Company, Ltd., is used as the liquid discharge apparatus 1.

In the carriage 10A on the front side, the heads 22Y, 22M, 22C, and 22K that discharge, respectively, yellow ink, magenta ink, cyan ink, and black ink are arranged in parallel. In addition, the heads 22D1 to 22D4 that discharge a diluent are disposed adjacent to the heads 22Y, 22M, 22C, and 22K, respectively. In the carriage 10B on the back side, the heads 22W1 and 22W2 that discharge white ink and the heads 22P1 and 22P2 that discharge a pretreatment liquid are arranged in parallel. In addition, the heads 22D5 to 22D8 that discharge the diluent are disposed adjacent to the heads 22W1, 22W2, 22P1, and 22P2, respectively.

In the illustrated example, during the maintenance, for example, the heads 22D1 to 22D8 discharge the diluent from the nozzles and apply the diluent to a wiping sheet (an example of the wiping member). Then, the wiping sheet wipes the heads that discharge the ink and the heads that discharge the pretreatment liquid. Thus, the liquid discharge apparatus 1 can clean the nozzle faces of the heads that discharge the ink and the heads that discharge the pretreatment liquid.

As in the illustrated example, the nozzle faces of the heads that discharge the ink and the nozzle faces of the heads that discharge the diluent are preferably disposed adjacent to one another. In this case, the wiping member to which the diluent has been applied can easily wipe the nozzle faces of the heads that discharge the ink. Similarly, the nozzle faces of the heads that discharge the pretreatment liquid and the nozzle faces of the heads that discharge the diluent are preferably disposed adjacent to one other. In this case, the wiping member to which the diluent has been applied can easily wipe the nozzle faces of the heads that discharge the pretreatment liquid.

As in the illustrated example, in the carriage 10A, the nozzle face of the head that discharges the ink and the nozzle face of the head that discharges the diluent are preferably even (disposed on the same plane) and grouped as one pair. This arrangement can prevent the piping near the nozzles from becoming complicated. Similarly, in the carriage 10B, the nozzle face of the head that discharges the pretreatment liquid and the nozzle face of the head that discharges the diluent are preferably even (disposed on the same plane) and grouped as one pair. This arrangement can prevent the piping near the nozzles from becoming complicated.

In the present example, the heads 22Y, 22M, 22C, 22K, 22W1, and 22W2 serve as the first discharge units, the heads 22P1 and 22P2 serve as the second discharge units, and the heads 22D1 to 22D8 serve as the third discharge unit.

The types and number of color inks to be discharged are not limited to the example illustrated in FIG. 5A. The colors of the color inks are not limited to black (K), cyan (C), magenta (M), and yellow (Y). The number of color inks may be one. The number of rows of the nozzles through which white ink is to be discharged is not limited to the illustrated example. Similarly, the number of heads that discharge the pretreatment liquid and the diluent and the number of rows of the nozzles of these heads are not limited to the illustrated examples.

FIG. 5B is a schematic plan view of the nozzles arranged in the head 22K and the nozzles arranged in the head 22D4 of FIG. 5A. FIG. 5B illustrates the nozzle face of the head 22K and the nozzle face of the head 22D4. For example, the heads are mounted in the liquid discharge apparatus 1 so that the nozzle faces face downward, and liquid is discharged downward (from top to bottom).

For the sake of explanation, the black ink is to be discharged from nozzles 65, and the diluent is to be discharged from nozzles 61. For example, the shape and size of each nozzle can be changed as appropriate.

In the illustrated example, the nozzles 61 are arrayed in two rows in the head 22D4, and the nozzles 65 are arrayed in two rows in the head 22K. When the nozzles are arrayed in two rows, the liquid discharge apparatus can perform high-speed printing. In the illustrated example, the nozzle rows are shifted from each other, for example, the nozzles are disposed in a staggered manner. In this case, liquid is simultaneously discharged from the two rows of the nozzles, and thus a solid image can be formed. During the maintenance, as described above, the diluent is discharged from the nozzles of the head that discharges the diluent. The diluent is applied to the wiping member, and the wiping member holding the diluent wipes the nozzle faces of the other heads. As a result, the nozzle faces can be cleaned.

When one liquid discharge apparatus discharges both the pretreatment liquid and the ink, a mist of the pretreatment liquid may remain in the apparatus after the pretreatment liquid is discharged. In this case, the discharged ink may react with the mist of the pretreatment liquid and be solidified. As a result, the solidified ink may adhere to the nozzle faces or the interior of the system, causing an ink stain. To prevent the ink stain, the liquid discharge apparatus 1 according to the present embodiment includes the head that discharges the diluent.

To remove the mist of the pretreatment liquid and the ink which have adhered to the nozzle faces, typically, a rubber wiper of the maintenance unit 30 mounted in the liquid discharge apparatus 1 wipes the nozzle faces. With such a method, the nozzle faces to which the pretreatment liquid and the ink have adhered can be wiped, but ink that has been reacted with the pretreatment liquid and solidified is difficult for the wiper to remove from the nozzle faces. In addition, thread waste generated from cloth may adhere to the nozzle faces, leading to a failure in the wiping operation by the wiper.

In the present embodiment, the wiping operation with the diluent can prevent the above situation. An example of this case will be described below.

In the present embodiment, each of the first discharge unit, the second discharge unit, and the third discharge unit has the nozzle face on which the nozzles are formed. The respective liquids are dischargeable from the corresponding nozzles. The liquid discharge apparatus according to the present embodiment includes a wiping member that wipes the nozzle face of the first discharge unit, the second discharge unit, and the third discharge unit and applies the diluent to the wiping member to perform the wiping operation with the diluent.

Such a configuration can appropriately clean the nozzle faces. Furthermore, thread waste and other substances that have adhered to the nozzle faces can be easily removed. This wiping operation is preferably performed on the pretreatment liquid and the ink that have adhered to the nozzle faces but have not reacted and not been solidified, i.e., have remained in a liquid state.

The method of applying the diluent to the wiping member is not particularly limited and can be selected as appropriate.

The third discharge unit according to the present embodiment can slightly discharge (in other words, advance, feed, or supply) the diluent from the nozzles and keep a discharged diluent in areas around the nozzles. The wiping member wipes the nozzle face of the third discharge unit to receive the discharged diluent and holds a received diluent from the nozzle face of the third discharge unit. After that, the wiping member wipes at least one of the nozzle face of the first discharge unit or the nozzle face of the second discharge unit with a received diluent.

Such a configuration of the head is not greatly different in the liquid discharge apparatus 1, and thus can reduce an increase in manufacturing costs. When the wiping member wipes the nozzle face of the third discharge unit, the diluent is applied to the wiping member, so that the wiping member can easily hold the diluent. To cause the diluent to ooze out through the nozzles (i.e., to slightly discharge the diluent) and keep the diluent in areas around the nozzles, for example, the third discharge unit is driven at a low drive frequency. Accordingly, the liquid discharge apparatus 1 can apply the diluent to the wiping member without employing a complicated configuration.

To adjust the amount of the diluent held by the wiping member, for example, the number of operations (i.e., a slight discharge operation by the third discharge unit) of causing the diluent to ooze out and the number of operations (i.e., a wiping operation of the third discharge unit) of wiping the nozzle face of the third discharge unit are adjusted as appropriate. When the amount of the diluent held by the wiping member is small, the slight discharge operation and the wiping operation of the third discharge unit are performed multiple times.

The wiping member may wipe only areas around the nozzles on the nozzle face of the third discharge unit or may wipe the entire nozzle face of the third discharge unit.

Examples of the wiping member include a wiper and a web, and the wiper is preferable. When the wiper is used, the third discharge unit slightly discharges the diluent, and the wiper wipes the nozzle face of the third discharge unit. As a result, the diluent can be easily applied to the wiper. Alternatively, the diluent may be applied to the web to perform a cleaning operation.

For example, the wiper may be referred to as a wiper member or may a wiper-shaped wiping member. The wiper may be a blade-shaped wiper blade, for example, made of rubber.

An example of the slight discharge operation is described below.

The third discharge unit according to the present embodiment preferably includes a driver that causes the third discharge unit to discharge the diluent from the nozzle. The driver drives the third discharge unit with a drive frequency of 7 kHz or less to perform the slight discharge operation. When the driver drives the third discharge unit with a drive frequency of 7 kHz or less, the diluent does not fly from the nozzle as a droplet, and an appropriate amount of diluent can be kept in areas around the nozzles.

The drive frequency of 10 kHz or less causes the diluent not to fly from the nozzle as a droplet. The drive frequency of 7 kHz or less causes an appropriate amount of the diluent to be kept in areas around the nozzles. The drive frequency of 1 kHz or more causes the diluent to be discharged from the nozzles.

Keeping the diluent in areas around the nozzles may be referred to as, for example, causing the diluent to remain in areas around the nozzles. Keeping the diluent in areas around the nozzles may also be referred to as, for example, keeping the diluent on the nozzle face. The wiping member performs the wiping operation, for example, after the printing operation or during maintenance.

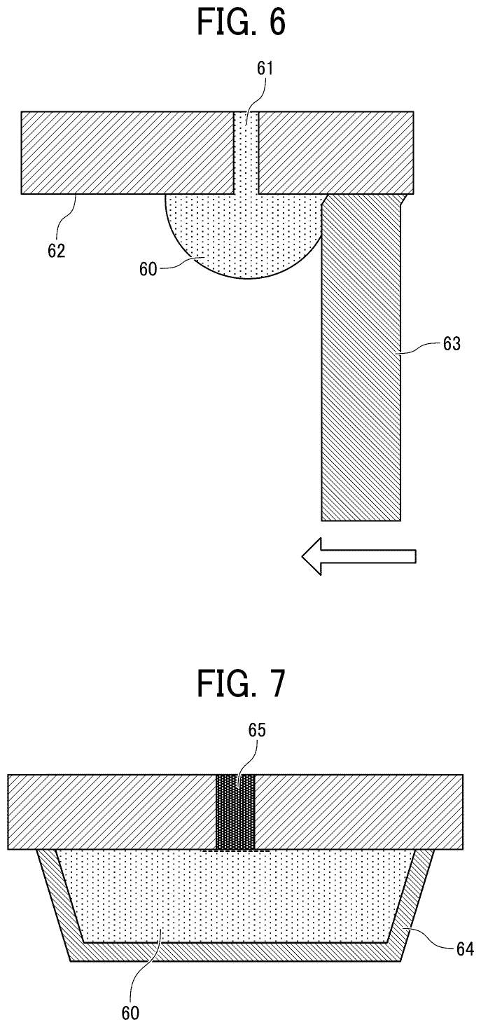

FIG. 6 is a schematic cross-sectional view of the third discharge unit and the wiping member according to the present embodiment. In FIG. 6, the nozzle 61 and a nozzle face 62 of the third discharge unit are illustrated, and a wiper 63 is illustrated as the wiping member. The blank arrow in FIG. 6 schematically indicates the moving direction of the wiper 63.

In this example, the drive frequency set to 1 to 7 kHz causes a diluent 60 to ooze out.

As illustrated, the diluent 60 does not fly as a droplet and remains on the nozzle face 62 in a hemispherical shape. When the wiper 63 wipes the nozzle face 62, the diluent 60 that has remained on the nozzle face 62 adheres to the wiper 63. In other words, the wiper 63 can receive the diluent 60 from the nozzle face 62.

By wiping the nozzle face to which the pretreatment liquid has adhered with the wiper 63 holding the diluent, the nozzle face can be kept clean. In addition, by wiping the nozzle face with the wiper 63 holding the diluent, the solidified ink can be removed to keep the nozzle face clean. Furthermore, by wiping the nozzle face 62 with the wiper 63 to which the diluent has adhered, solid matter is unlikely to adhere to the wiper, so that the surface of the wiper can be easily kept clean.

In the example illustrated in FIGS. 5A and 5B, for example, by wiping the nozzle faces of heads 22D7 and 22D8 with the wiping member, the diluent can be applied to the wiping member. Then, by wiping the heads 22P1 and 22P2 with the wiping member in the same direction, the nozzle faces and the surroundings of the heads that discharge the pretreatment liquid can be wiped with the diluent. For example, after the wiping member wipes the nozzle faces of the heads 22D1 to 22D6 so that the diluent is applied to the wiping member, the wiping member is moved toward the corresponding heads 22Y, 22M, 22C, 22K, 22W1, and 22W2 and wipes the heads 22Y, 22M, 22C, 22K, 22W1, and 22W2. Thus, the areas around the nozzles from which the ink is to be discharged and the nozzle face can be wiped with the diluent.

In the present embodiment, as described above, the application of the diluent is not limited to wiping, and the diluent may be used for another purpose. For example, the diluent may be used for a cap. An example of this case will be described below.

The liquid discharge apparatus according to the present embodiment includes a cap that caps (covers) at least one of the first discharge unit or the second discharge unit. The third discharge unit discharges the diluent to the cap, and then the cap caps at least one of the first discharge unit or the second discharge unit with the diluent held in the cap.

The cap holding the diluent covers the nozzles to prevent the pretreatment liquid or the ink from being dried. For example, even when the printing operation is not performed for a long time, the nozzles are not clogged with the pretreatment liquid or the ink, and thus the discharge failure can be prevented. By capping at least one of the first discharge unit or the second discharge unit with the cap holding the diluent therein, the nozzle faces of the first discharge unit and the second discharge unit can be kept clean. Furthermore, by capping at least one of the first discharge unit or the second discharge unit with the cap holding the diluent therein, the nozzle face of the first discharge unit and the nozzle face of the second discharge unit can be cleaned.

FIG. 7 is a schematic cross-sectional view of the head and the cap according to the present embodiment. In this example, the third discharge unit discharges the diluent 60 to a cap 64 so that the diluent 60 is held inside the cap 64. The cap 64 caps the nozzle face of the first discharge unit or the second discharge unit while holding the diluent 60.

In FIG. 7, the nozzle 65 is illustrated, which is distinguished from the nozzle 61 of the third discharge unit in FIG. 6. The cap 64 caps at least one of the first discharge unit or the second discharge unit. For example, the cap 64 caps the head 22K (the first discharge unit) having the nozzle 65, which is different from the nozzle 61 of the third discharge unit. The cap 64 may cap one head or may cap multiple heads together. The cap may be referred to as, for example, a head protection cap, or may be referred to as a cap member.

In FIG. 7, for the sake of explanation, a broken line is drawn between the nozzle 65 and the diluent 60 held in the cap 64. The diluent 60 in the cap 64 is preferably in contact with the nozzle 65. Due to the contact, the nozzle face of the discharge unit can be sufficiently cleaned.

Another embodiment of the present disclosure is described below.

A liquid discharge apparatus 1 according to an embodiment of the present disclosure can also be applied to a DTF printer. An example of this application is described below.

In the DTF system, a transfer substrate from which an image is to be transferred to a transfer target is used as a recording medium. The liquid discharge apparatus 1 discharges the pretreatment liquid and ink onto the transfer substrate to form the image to be transferred. The pretreatment liquid is supplementally described below. If the ink has good affinity for the transfer substrate, the pretreatment liquid is unnecessary. In fact, since the transfer substrate is coated with a dedicated coating agent, aqueous ink has good affinity for the transfer substrate. Some transfer substrates, however, have the property of repelling ink. The pretreatment liquid is used as a binder (also referred to as an adhesive liquid, glue, etc.) that helps transferring of an image from the transfer substrate to a transfer target, such as a garment. In this way, the image can be transferred to the transfer target.

The transfer substrate is preferably a non-permeable substrate, and an example of the non-permeable substrate is a film.

The transfer target onto which an image is to be transferred is preferably cloth. Examples of the cloth include garments, such as T-shirts, and bags.

When the image is transferred from the transfer substrate to the transfer target, a heating or pressing process may be applied to the transfer substrate and the transfer target. The heating and/or pressing process facilitates the transferring of the image.

In the DTF system, the third discharge unit may discharge the diluent to the image that has been transferred to the transfer target. When discharging the diluent to the image that has been transferred to the transfer target, the third discharge unit discharges the diluent to a portion of the image that has been transferred to the transfer target. In this case, by applying the diluent to a discolored portion of the image that has been transferred to the transfer target, the discoloration can be eliminated. Alternatively, the discoloration can be reduced.

An example of the above case is described below.

The liquid discharge apparatus 1 according to the present embodiment discharged the pretreatment liquid and the ink onto a recording medium, which was a transfer substrate, to form an image to be transferred. In this example, the liquid discharge apparatus 1 formed a black image with black ink. Then, the liquid discharge apparatus 1 transferred the image from the recording medium to a T-shirt, which was a transfer target. In this case, a portion of the black image on the periphery of the printing area was discolored white. The reason for the white discoloration may be caused by, for example, the main ingredient of the pretreatment liquid that is turned white and becomes noticeable through drying. Preferably, an area to which the pretreatment liquid is applied is as large as an area of a printed image. However, depending on the type of T-shirt (material, twisting of thread, etc.), the pretreatment liquid may unexpectedly spread out. When the diluent was sprayed (discharged) onto the discolored portion, the discoloration was eliminated. Although details are not clear, applying the diluent to the discolored portion was effective in eliminating the discoloration of the transferred image. Even when the diluent was sprayed (discharged), the image that had been transferred to the transfer target is not blurred. Thus, in the DTF system, discharging the diluent to the image that has been transferred to the transfer target is effective.

As an example of a method of discharging the diluent to a portion (e.g., a discolored portion) of an image that has been transferred to the transfer target, the discolored portion is determined by, for example, a reflective image densitometer, and the diluent is discharged to the determined portion from the nozzles 61 corresponding to the discolored portion. Aspects of the present disclosure are, for example, as follows.

### Aspect 1

A liquid discharge apparatus includes a first discharge unit that discharges ink onto a recording medium, a second discharge unit that discharges a pretreatment liquid to an area to which the ink is to be discharged, and a third discharge unit that discharges a diluent.

In other words, a liquid discharge apparatus includes a first discharge unit, a second discharge unit, and a third discharge unit. The first discharge unit has a first nozzle face having a first nozzle to discharge ink from the first nozzle onto an area of a recording medium to form an image on the recording medium. The second discharge unit has a second nozzle face having a second nozzle to discharge a pretreatment liquid from the second nozzle to the area of the recording medium. The third discharge unit has a third nozzle face having a third nozzle to discharge a diluent from the third nozzle.

### Aspect 2

In the liquid discharge apparatus according to Aspect 1, the diluent dilutes at least one of the pretreatment liquid or the ink.

In other words, the third discharge unit discharges the diluent to dilute at least one of the pretreatment liquid or the ink.

### Aspect 3

In the liquid discharge apparatus according to Aspect 1 or 2, each of the first discharge unit, the second discharge unit, and the third discharge unit has a nozzle face on which a nozzle, through which a corresponding liquid is to be discharged, is formed. The liquid discharge apparatus further includes a wiping member that wipes the nozzle face of the first discharge unit, the second discharge unit, or the third discharge unit. The diluent is applied to the wiping member to wipe the nozzle face.

In other words, the liquid discharge apparatus according to Aspect 1 or 2, further includes a wiper to wipe the first nozzle face, the second nozzle face, or the third nozzle face with the diluent applied on the wiper by the third discharge unit.

### Aspect 4

In the liquid discharge apparatus according to Aspect 3, the third discharge unit causes the diluent to ooze out through the nozzle to keep the diluent in an area around the nozzle. The wiping member wipes the nozzle face of the third discharge unit to hold the diluent and wipes at least one of the nozzle face of the first discharge unit or the nozzle face of the second discharge unit.

In other words, the third discharge unit advances and keeps the diluent in an area around the third nozzle on the third nozzle face. The wiper wipes the third nozzle face, receives the diluent kept in the area around the third nozzle from the third nozzle face by wiping the third nozzle face, holds the diluent received from the third nozzle face on the wiper, and wipes at least one of the first nozzle face or the second nozzle face with the diluent held on the wiper.

### Aspect 5

In the liquid discharge apparatus according to Aspect 4, the third discharge unit includes a driver that operates to discharge the diluent. The driver causes the diluent to ooze out through the nozzle at a drive frequency of 7 kHz or less.

In other words, the third discharge unit includes a driver to drive the third discharge unit with a drive frequency of 7 kHz or less to advance the diluent to the area around the third nozzle.

### Aspect 6

In the liquid discharge apparatus according to any one of Aspects 1 to 5, the ink contains an organic solvent as a main ingredient.

In other words, the ink includes an organic solvent.

### Aspect 7

The liquid discharge apparatus according to any one of Aspects 1 to 5, further incudes an irradiation unit that emits ultraviolet light. The ink is ultraviolet-curable ink.

In other words, the liquid discharge apparatus according to any one of Aspects 1 to 5, further includes an irradiation unit to emit ultraviolet light to the ink discharged on the recording medium to cure the ink.

### Aspect 8

The liquid discharge apparatus according to any one of Aspects 1 to 7, further includes a cap that caps at least one of the first discharge unit or the second discharge unit. The third discharge unit discharges the diluent to the cap, and the cap caps at least one of the first discharge unit or the second discharge unit with the diluent held in the cap.

In other words, the liquid discharge apparatus according to any one of Aspects 1 to 7, further includes a cap holdable the diluent discharged from the third discharge unit. The cap covers at least one of the first discharge unit or the second discharge unit with the diluent held in the cap.

### Aspect 9

In the liquid discharge apparatus according to any one of Aspects 1 to 8, the diluent is water.

In other words, the diluent includes water.

### Aspect 10

In the liquid discharge apparatus according to any one of Aspects 1 to 8, the diluent is a cleaning liquid, and the cleaning liquid contains an organic solvent, a surfactant, and water.

In other words, the diluent includes a cleaning liquid including an organic solvent, a surfactant, and water.

### Aspect 11

In the liquid discharge apparatus according to any one of Aspects 1 to 10, the ink includes color ink and white ink, and the recording medium is cloth. When the recording medium has a color other than white, the first discharge unit discharges the white ink onto the recording medium and discharges the color ink to an area to which the white ink has been discharged.

In other words, the first discharge unit discharges the ink including color ink and white ink onto the recording medium including cloth having a color other than white. The first discharge unit discharges the white ink onto an area of the recording medium and discharges the color ink to the area of the recording medium to which the white ink has been discharged.

### Aspect 12

In the liquid discharge apparatus according to any one of Aspects 1 to 10, the recording medium is a transfer substrate from which an image is to be transferred to a transfer target.

In other words, the first discharge unit discharges the ink from the first nozzle onto a transfer substrate from which the image is transferable to a transfer target.

### Aspect 13

In the liquid discharge apparatus according to Aspect 12, the transfer substrate is a non-permeable substrate, and the transfer target is cloth.

In other words, the first discharge unit discharges the ink from the first nozzle onto the transfer substrate including a non-permeable substrate from which the image is transferable to the transfer target including cloth.

### Aspect 14

In the liquid discharge apparatus according to Aspect 12 or 13, the third discharge unit discharges the diluent onto the image that has been transferred to the transfer target.

### Aspect 15

In the liquid discharge apparatus according to Aspect 14, when the third discharge unit discharges the diluent to the image that has been transferred to the transfer target, the third discharge unit discharges the diluent to a portion of the image that has been transferred to the transfer target.

In other words, the third discharge unit discharges the diluent to a portion of the image that has been transferred to the transfer target.

As described above, according to one aspect of the present disclosure, a liquid discharge apparatus can be provided that keeps an area around a nozzle clean and prevents an increase in manufacturing costs.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge apparatus comprising:
a first discharge unit having a first nozzle face having a first nozzle to discharge ink from the first nozzle onto an area of a recording medium to form an image on the recording medium;
a second discharge unit having a second nozzle face having a second nozzle to discharge a pretreatment liquid from the second nozzle to the area of the recording medium; and
a third discharge unit having a third nozzle face having a third nozzle to discharge a diluent from the third nozzle.

2. The liquid discharge apparatus according to claim 1,
wherein the third discharge unit discharges the diluent to dilute at least one of the pretreatment liquid or the ink.

3. The liquid discharge apparatus according to claim 1, further comprising a wiper to wipe the first nozzle face, the second nozzle face, or the third nozzle face with the diluent applied on the wiper by the third discharge unit.

4. The liquid discharge apparatus according to claim 3,
wherein the third discharge unit advances and keeps the diluent in an area around the third nozzle on the third nozzle face, and
the wiper:
wipes the third nozzle face;
receives the diluent kept in the area around the third nozzle from the third nozzle face by wiping the third nozzle face;
holds the diluent received from the third nozzle face on the wiper; and
wipes at least one of the first nozzle face or the second nozzle face with the diluent held on the wiper.

5. The liquid discharge apparatus according to claim 4,
wherein the third discharge unit includes a driver to drive the third discharge unit with a drive frequency of 7 kHz or less to advance the diluent to the area around the third nozzle.

6. The liquid discharge apparatus according to claim 1,
wherein the ink includes an organic solvent.

7. The liquid discharge apparatus according to claim 1, further comprising an irradiation unit to emit ultraviolet light to the ink discharged on the recording medium to cure the ink.

8. The liquid discharge apparatus according to claim 1, further comprising a cap holdable the diluent discharged from the third discharge unit,
wherein the cap covers at least one of the first discharge unit or the second discharge unit with the diluent held in the cap.

9. The liquid discharge apparatus according to claim 1,
wherein the diluent includes water.

10. The liquid discharge apparatus according to claim 1,
wherein the diluent includes a cleaning liquid including an organic solvent, a surfactant, and water.

11. The liquid discharge apparatus according to claim 1,
wherein the first discharge unit discharges the ink including color ink and white ink onto the recording medium including cloth having a color other than white, and
the first discharge unit discharges the white ink onto an area of the recording medium and discharges the color ink to the area of the recording medium to which the white ink has been discharged.

12. The liquid discharge apparatus according to claim 1,
wherein the first discharge unit discharges the ink from the first nozzle onto a transfer substrate from which the image is transferable to a transfer target.

13. The liquid discharge apparatus according to claim 12,
wherein the first discharge unit discharges the ink from the first nozzle onto the transfer substrate including a non-permeable substrate from which the image is transferable to the transfer target including cloth.

14. The liquid discharge apparatus according to claim 12,
wherein the third discharge unit discharges the diluent onto the image that has been transferred to the transfer target.

15. The liquid discharge apparatus according to claim 14,
wherein the third discharge unit discharges the diluent to a portion of the image that has been transferred to the transfer target.
